(19) United States
(12) Patent Application Publication
(10) Pub. No.: US 2014/0251914 A1
(43) Pub. Date: Sep. 11, 2014

(54) METHOD FOR TREATING ACID MINE DRAINAGE

(71) Applicants: Brandon Ryan Ball, Fox Island, WA (US); Rahul Shankar Bhaduri, Moraga, CA (US); Derek Anderson Eggert, Houston, TX (US); Prakhar Prakash, Danville, CA (US)

(72) Inventors: Brandon Ryan Ball, Fox Island, WA (US); Rahul Shankar Bhaduri, Moraga, CA (US); Derek Anderson Eggert, Houston, TX (US); Prakhar Prakash, Danville, CA (US)

(21) Appl. No.: 13/787,977

(22) Filed: Mar. 7, 2013

(51) Int. Cl. C02F 9/00

(52) U.S. Cl. CPC C02F 9/00
USPC 210/667

(57) ABSTRACT

A process for treating acid mine drainage containing heavy and base metals and soluble contaminants is provided. In one embodiment, at least a metal cation is added to the acid mine drainage at a pre-select pH to form insoluble heavy and base metal complexes. After the removal of the heavy and base metal complexes, the pH is raised to the alkaline range. Following removal of base metal hydroxides and gypsum, membrane filtration is employed to generate a treated membrane permeate having a reduced concentration of heavy and base metals and soluble contaminants, and a membrane reject stream containing a concentrated brine. The concentrated brine is further treated with additional lime and at least an aluminum salt to remove remaining soluble contaminants, thus producing a treated water stream with reduced levels of contaminants. Carbonation with CO₂ is employed at the end of the process to neutralize flows and further precipitate residual aluminum and calcium salts.

### TECHNICAL FIELD

The invention relates to methods for treating waste, drainage, and effluent waters emanating from sources including but not limited to excavations and mining operations.

### BACKGROUND

Environmental regulations throughout the world such as those promulgated by the US EPA under CAA, RCRA and CERCLA, as well as state and local authorities, require material producers to manage water effluents and wastes from extractions/excavations. Concentration of certain minerals/metals in water effluents must be contained below regulatory levels. Many states in the US have standards for the treatment of reclaimed water to be used for crop irrigation. State agencies, e.g., the Colorado Department of Public Health and Environment (DPHE), have classifications system establishing water use categories. Waters are classified according to the uses for which they are presently suitable or intended to become suitable, e.g., domestic water supply, irrigation of crop, etc. For example, the 2000 DPHE MCL (“Maximum Contaminant Level”) standard for nitrate/nitrite in irrigation water is 100 mg/L, the total dissolved solids (TDS) MCL is 500 mg/L, the fluoride MCL is 4 mg/L, the sulfate MCL is 500 mg/L. No MCL currently exists for vanadium; however, the Superfund Removal Action Level for vanadium is 250 ug/l. New Mexico MCL for arsenic is 0.010 mg/L. The EPA has not established an MCL for molybdenum in drinking water. The EPA has developed a health advisory for children of 0.08 mg/L and a lifetime health advisory of 0.04 mg/L of molybdenum in drinking water. Water quality criteria and/or MCLs have also been established for many heavy and base metals including aluminum, copper, manganese, nickel, lead, selenium, vanadium, and zinc.

Excavations such as mining operations, milling operations, groundwater extraction, road constructions, etc., generate effluents which may require treatment prior to discharge. These effluents include, for example, acid mine drainage (AMD), mill tailings, excess decant water, seepages, and acidic process waste streams. Acid mine drainage (AMD) forms when minerals in rocks are exposed to oxidizing conditions in mining operations, highway construction, and other large scale excavations.

There is a need for improved methods for treating mine effluents, particularly effluents with concentrations of anions such as fluorides, sulfates, molybdates, arsenates, selenites, selenates, etc., as well as heavy and base metals such as nickel, cobalt, manganese, chromium, and the like, meeting surface water or ground water criteria, while maximizing the reuse potential of treated water and minimizing the amount of sludge generated in the treatment process.

### SUMMARY OF THE INVENTION

In one aspect, there is provided a method for treating acid mine drainage to reduce the concentration of metals and soluble contaminants. The acid mine drainage contains one or more metal ions selected from antimony (Sb), molybdenum (Mo), vanadium (V) arsenic (As), aluminum (Al), cadmium (Cd), cobalt (Co), copper (Cu), manganese (Mn), lead (Pb), nickel (Ni), selenium (Se) and zinc (Zn) and at least a soluble anionic species selected from nitrate, nitrite, sulfate, fluoride, selenite, selenate, and chloride. The method comprises the steps of: contacting the discharge stream with a metal cation selected from divalent and trivalent metal cations and mixtures thereof, at a pre-select pH and in an amount effective for the metal cation to form at least an metal complex with one or more of the metals; performing a liquid solid separation to remove the metal complex forming a first effluent stream; adjusting the pH of the first effluent stream to a second pre-select pH to generate a first precipitate; performing a liquid solid separation to remove the first precipitate to generate a second effluent stream; passing the second effluent stream to a filtration device having at least a membrane element to generate a permeate stream and a reject stream supersaturated with calcium sulfate; performing a settling and a liquid solid separation step to remove at least a portion of the calcium sulfate, forming a supernatant having a reduced concentration of calcium sulfate; adding at least an aluminum salt to the supernatant for the soluble anionic species to react with the aluminum salt to form a second precipitate at an alkaline pH; performing a liquid solid separation to remove the second precipitate to form a third effluent.

In one embodiment, the first effluent contains less than 0.1 ppm of Mo, As, V, and Sb each; the permeate stream has a concentration of less than 0.0001 mg/L of Cu, Cd, Co, and Pb; less than 0.005 ppm of Ni and Zinc, less than 0.1 mg/L of Mo; and less than 0.005 mg/L of Se; and the third effluent has a TSS level of less than 10 mg/L, a TDS of less than 1,000 mg/L, including chloride levels of less than 200 mg/L, sulfate levels of less than 300 mg/L and less than 1 mg/L fluoride. The metal cation is ferric chloride and the aluminum salt is calcium aluminate in one embodiment.

### BRIEF DESCRIPTION OF THE DRAWING

FIG. 1 is a block diagram illustrating an embodiment of a process to treat acid mine drainage to reduce contaminants.

### DETAILED DESCRIPTION

The following terms will be used throughout the specification and will have the following meanings unless otherwise indicated.

“ppm” refers to parts per million. One ppm is equivalent to 1 mg per liter.

“Divalent metal cation” and “trivalent metal cation” refer to a metal cation in its divalent state and trivalent state, respectively. For example, ferric sulfate is trivalent ferric iron and ferrous sulfate is divalent ferrous iron.

“Tailings” or “tailing” (also known as slimes, tails, or leach residue) refers to waste or materials remaining after the process of separating the valuable fraction from the uneconomic fraction of an ore.

Overburden or waste rock refers to the materials overlying an ore or mineral body that are displaced during mining without being processed.

“AMD” or acid mine drainage, or acid rock drainage (ARD), refers to effluents from surface water drainage, extractions and/or excavations, characterized by acidity and metals which may include aluminum, antimony, cadmium, chromium, cobalt, copper, iron, lead, magnesium, manganese, molybdenum, nickel, selenium, zinc and others. In one embodiment, AMD is a consequence of the decomposition of pyrite (FeS₂) and pyrrhotite [Fe(₁₋ₓ)S] in waste rock upon exposure to water and oxygen, resulting in the groundwater becoming acidified and contaminated with dissolved metals and sulfates.

The term mine here includes mining, referring to active, inactive, or abandoned extraction and or excavation operations for removing minerals, metals, ores and/or coal from the earth. Examples of extraction operations include minerals, metals and ores including limestone, talc, gold, silver, iron, zinc, manganese, molybdenum, antimony, chromium, and nickel.

“Aerated” refers to the natural and/or mechanical methods of mixing air and water. Any suitable mechanical aeration device can be used. Suitable devices are described in U.S. Pat. Nos. 3,142,639 and 4,695,379, the references are including herein by reference.

“Spillway” refers to a waterway beginning at a point of discharge from a final settling pond at a water treatment site and ending where the water in the waterway enters a naturally occurring waterway through gravity flow. Non-limiting examples of suitable waterways include spillways, rivers, streams, lakes, and the like.

In one embodiment, the invention relates to an improved method to remove and or treat contaminants/minerals from AMD, e.g., effluents, run-off, discharge streams, and seepage, from plants, mines, coal refuse piles, construction sites, and other locations wherein rock formations have been disturbed, excavated, exposed to water sources such as rainfall, surface water, and subsurface water sources, such that the water contains metals and minerals in solution or suspension. Specifically, the invention relates to an improved method for treating AMD to reduce “contaminants of concerns” (COC's) including heavy and base metals such as chromium, cobalt, zinc, nickel etc., and anionic species such as arsenate, vanadate, molybdate, fluoride and sulfate down to a level meeting regulatory requirements, combining enhanced chemical precipitation process steps with nano-filtration treatment, for treated water meeting regulatory requirements that can be returned to the environment or be recycled and reused in the milling process.

AMD Contaminants For Treatment: As used herein, the term AMD refers to the water to be treated, which includes all sources of effluents from excavations, including AMD as well as tailings water and effluents, seepage from tailings facilities, leach residues, as well as seepage, well water, mine water and effluents from waste rock piles obtained from the excavation.

The term “treatment” refers to the steps or processes for the removal of metals and dissolved anionic species in AMD. It is not a single step or process, but can occur at various stages of the process to be described herein, where combinations of chemical and/or physical mechanisms are involved.

Depending on the location and amount of mineral deposits, the AMD in one embodiment is from an ore containing materials including magnetite, zircon, rutile, manganosiderite, fluorite, molybdenite, chalcopyrite, sphalerite, galena and fluorite. In one embodiment, some ores may include light gravity minerals (less than 2.9 specific gravity) such as quartz, orthoclase, oligoclase, biotite, calcite, and chlorite.

Depending on the ore location, the mineralogy of AMD in one embodiment may comprise quartz, plagioclase feldspar, potassium feldspar, biotite, chlorite, amphibole, calcite and sulfide minerals. The sulfide minerals in one embodiment include pyrite, sphalerite, chalcopyrite and molybdenite with trace amounts of galena, covellite and pyrrhotite, with the minerals as potential sources of acidity and dissolved metals including aluminum, cadmium, chromium, cobalt, copper, iron, lead, magnesium, manganese, molybdenum, nickel, zinc and others.

Depending on the source, the excavation means, the tailing impoundment means, the water source, the AMD in one embodiment contains soluble species including but not limited to fluorides, sulfates, cadmium, cobalt, manganese, molybdenum, and nickel. In another embodiment, the AMD contains one or more metal ions or salts of iron, copper, zinc, lead, mercury, cadmium, arsenic, barium, selenium, silver, chromium, aluminum, manganese, nickel, cobalt, uranium, and antimony.

In one embodiment, the AMD has a pH from 2.0 to 7.0; often from 3.0 to 6.0 and typically in the range of 3.5 to 5.5. The AMD has a calcium hardness of greater than 200 ppm in one embodiment; greater than 400 ppm in a second embodiment; and greater than 600 ppm in a third embodiment.

One heavy or base metal that may be dissolved in aqueous effluents of base metal mines is molybdenum. In one embodiment of tailing ponds associated with copper mines, the Mo concentration ranges from 1 to 30 ppm. In another embodiment, the tailings water from a uranium mill contains dissolved Mo in an amount of up to 900 ppm.

Removal of Heavy and Base Metals from the AMD: In one embodiment, the pH of the AMD is first adjusted to a pH value at which selective precipitation of the heavy and base metal complexes occurs (“pre-selected pH”) with the addition of at least a metal cation selected from divalent and trivalent metal cations (“metal cation”), at a mass ratio of metal cation to heavy and base metals ranging from 2.5:1 to 20:1 and from 5:1 to 10:1 in a second embodiment. In one embodiment, the pre-select pH is between 2.0 to 6.0. In another embodiment, from 4.0 to 5.0. This can be accomplished by the addition of at least an acid with a relatively high ionization constant. In one embodiment, the acid is used in a strength ranging from 1.0 to 12.0 normal. In a second embodiment, hydrochloric acid is used in view of its availability and low cost. In a third embodiment, lime is used to adjust the pH.

The metal cation is added to the AMD to scavenge heavy and base metals such as molybdenum, tungsten, chromium, arsenic, antimony and vanadium from the AMD. In one embodiment, the metal cation is selected from the group of iron, cobalt, aluminum, rhenium, and combinations thereof Iron is employed in one embodiment. The metal cation is added to the AMD in an amount sufficient to provide from about 6 to 50 ppm (parts per million) of metal cation to each ppm of the metal to be removed from the AMD. The addition of the metal cation enables the formation of insoluble heavy and base metal complexes such as iron molybdates, tungstates, vanadates, antimonates, arsenates, etc., depending on the source and original concentration of heavy and base metals in the AMD.

By varying the concentration of the metal cations to heavy and base metal ions and the pH, nearly total removal of dissolved heavy and base metal ions can be achieved, wherein the heavy and base metal ions are converted to heavy and base metal insoluble complexes for subsequent removal. In one embodiment, at least 50% of the heavy and base metals can be removed as precipitate with the rest remaining in solution. In another embodiment, the removal rate is at least 75%. In a third embodiment, at least 90% of the heavy and base metals are removed as a precipitate. In yet another embodiment, the removal rate is at least 96% as precipitate. In one embodiment, the concentration of a heavy or base metal such as Mo is reduced to less than 0.050 ppm. In another embodiment, Mo is reduced to a level of 0.080 ppm or less.

In one embodiment, the metal cation is trivalent ferric ion, e.g., ferric sulfate, in view of its availability, low cost, and ease of use. In another embodiment, the metal cation is provided as ferric chloride solution. In another embodiment, the metal cation is divalent ferrous ion, e.g., ferrous sulfate. In yet another embodiment, the metal cation is aluminum, e.g., hydrous aluminum oxide, provided at a pH of about 5.2.

In one embodiment with the use of a divalent metal cation such as ferrous ion, oxidizing means such as aeration or an oxidizing agent is provided to convert the divalent metal ion into a trivalent metal ion, e.g., ferric iron. Air injection of the AMD stream/tank can be continuous or intermittent. The injection rate in one embodiment varies from 2 Lpm to 20 Lpm per 100 gpm (gallon per minute) flow for a conversion based on 50 ppm of ferrous ion, for full conversion into ferric ion, assuming 50% oxygen utilization. In another embodiment, hydrogen peroxide is employed to oxidize the divalent metal cation for the precipitating of the heavy and base metal complexes.

It should be noted that the “treatment” or contact time between the effluent AMD and the additive such as a metal cation, or the residence time in the mixing tank varies depending on factors including but not limited to the size of the equipment and effluent flow rate. In one embodiment, treatment with the metal cation is for at least a retention time of 3 minutes under agitation and aeration to enable the formation of the insoluble heavy and base metal precipitates. In another embodiment, the retention time ranges from 5 minutes to 2 hrs. In yet another embodiment, the retention time is for at least an hour. The treatment is at a temperature ranging from ambient to 60° C. in one embodiment, and from 40 to 80° C. in a second embodiment. The treatment can be suitably conducted at atmospheric pressure.

Liquid Solid Separation to Remove Solids: Depending on the source and concentration of the contaminants in the AMD, the level of solids containing heavy and base metal precipitate in the AMD after treatment can be quite low, e.g., less than 1 wt % in one embodiment, and less than 0.5 wt. % in a second embodiment. In the next step, the AMD stream containing heavy and base metal precipitates along with any insoluble iron oxyhydroxides is subject to liquid solid separation to remove effluent water for further treatment. The metal precipitate in one embodiment may be slime-like in character. In another embodiment, the precipitate may be in the form of suspended matter as fine particulates.

In one embodiment, the liquid solid separation is achieved via the ‘body feed’ addition of a material such as calcium silicate or diatomaceous earth or cellulose. In one example, the AMD slurry containing the insoluble metal complexes is body fed with 1,000-20,000 ppm of diatomaceous earth. The diatomaceous earth provides a matrix for holding the fine particulates together, assisting solids filterability through the use of a plate and frame filter.

In another embodiment, the liquid solid separation to remove the metal precipitate is via coagulation/flocculation/clarification. In one example, at least a flocculent is first added to the AMD. In one embodiment prior to the addition of the flocculent, the pH of the AMD is adjusted to control the size of the coagulated particles, density of the slime, as well as the tendency and rate of settling of the solids. Flocculants are well-known in the art. Examples include but are not limited to natural and synthetic organic polymers, e.g., anionic polymers such as hydrolyzed polyacrylamides. In one embodiment, the flocculent is commercially available Magnafloc™ 155 anionic polymer. The flocculent facilitates the precipitation of the heavy and base metal complexes. In one embodiment, the flocculent addition results in flocs that are buoyed to the surface which can be skimmed from the surface to remove the metal complexes. In another embodiment, the flocculent binds to the metal complexes, resulting in an aggregation of solids that subsequently settle out.

In one embodiment, inclined plate settlers or lamella clarifiers are employed for the flocculation/clarification step. AMD containing insoluble heavy and base metal complexes enters the lamella clarifier, where it is flash mixed with the polymer flocculent and then gently agitated with a separate mixer. In one embodiment, as the liquid flows up the inclined plates, the flocculated material containing the heavy and base metal complexes settle out from the stream, allowing water containing soluble cationic and anionic species to be collected for further treatment. After the removal of the insoluble metal complexes, the concentration of heavy and base metals such as Mo, V, As in the collected water effluent is reduced to 1 ppm in one embodiment, less than 0.5 ppm in another embodiment, and less than 0.1 ppm in a third embodiment.

pH Adjustment—Lime Treatment: In one embodiment after the removal of heavy and base metals such as Mo, V, As and Sb, the effluent water still contains soluble cationic and anionic species initially present in the AMD, such as aluminum, cadmium, cobalt, manganese, nickel, silica, fluorides, sulfates and the like. Prior to the removal of the soluble species to regulatory levels in one embodiment, the pH of the effluent water is first adjusted to an alkaline value at which maximum removal of contaminants will occur. In one embodiment, the alkaline pH is at between 9 and 11. In a second embodiment, the pre-select pH is at least 10. In a third embodiment, the pH is adjusted to a level of between 9.5 and 10.5. The pH can be increased in one embodiment with lime supplementation, or the addition of an aqueous base.

Membrane Filtration: After the lime pre-treatment, the effluent stream is clarified with the use of a thickener to remove suspended solids. The clarifier overflow is concentrated by membrane treatment to produce a clean permeate and a reject stream or brine containing the majority of the contaminants. The lime-treated water is exposed to a filtration device having at least a membrane element, such as a nano-filtration membrane or a reverse-osmosis (RO) membrane. In one embodiment, cross-flow filtration is employed, wherein the lime-treated water flows tangentially to the membrane, which allows solvent to flow through as permeate. In another embodiment of RO filtration, pressure greater than the osmotic pressure is applied on the side of the membrane containing the lime-treated water, which allows pure solvent to flow through as the permeate.

In both methods of filtration, the membrane permeate stream has a reduced concentration of soluble contaminants, while the membrane reject stream has an elevated concentration of soluble contaminants, e.g., in one embodiment from 2 to 10 times the concentration of the dissolved cations/anions in the stream prior to the membrane treatment; and 2-4 times the concentration of the soluble contaminants such as TDS, chloride, fluoride and sulfate in a second embodiment. In one embodiment, an anti-scalant, e.g., phosphonate, is added to the membrane influent at a concentration of 3-4 ppm to prevent scaling of the membrane by substances such as gypsum. The permeate stream has further reductions in the concentration of heavy and base metals, e.g., less than 0.0001 ppm of Cu, Cd, Co, Pb, and Sb; less than 0.001 ppm of Mo; and less than 0.005 ppm of Se.

The membrane reject stream in one embodiment ranges from 20-50 vol. % of the feed to the filter system. In a second embodiment, from 30 to 40 vol. %.

The membrane permeate stream can be returned to a milling process, or discharged into suitable waterways include spillways, rivers, streams, lakes, and the like, after the pH is neutralized to meet local effluent discharge regulations. The permeate stream can be combined with treated streams from other steps for pH neutralization before discharge.

Optional Calcium Sulfate (Gypsum) Desaturation: In one embodiment, the membrane reject stream or brine, containing soluble contaminants, is supersaturated with gypsum (calcium sulfate). Gypsum is known to precipitate and form scale on the surface of treatment equipment and lines. Gypsum can also interfere with the subsequent reaction mechanism to remove contaminants of concern. Gypsum in one embodiment is removed by settling, e.g., with the use of settling tanks and the addition of an anionic polymer anti-sealant. The anti-scalant has a short half-life, and the settling tank provides retention time to allow the anti-scalant to disperse, thus enabling supersaturated gypsum to precipitate and settle out. After desaturation, the concentration of sulfate in the concentrated brine stream ranges from 50 to 5,000 ppm in one embodiment; from 1,000-3,000 ppm in a second embodiment; and less than 500 ppm in a third embodiment. In yet another embodiment, the desaturation step removes from 10 to 50% of the calcium sulfate in the concentrated brine stream.

Aluminum Salt Treatment: After the gypsum desaturation step and removal of the settled solids, the concentrated brine stream contains elevated levels of soluble cationic and anionic species such as aluminum, manganese, selenium, fluorides, sulfates, total dissolved solids and the like. The concentration of these soluble species is further lowered with an aluminum salt treatment. Examples of aluminum salts include but are not limited to aluminum chloride, aluminum chlorohydrate, polyaluminum chloride, aluminum sulfate, silicoaluminate, polyaluminum chlorosulfate; aluminate salts such as calcium chloroaluminate, calcium sulfoaluminate, sodium aluminate, potassium aluminate, calcium aluminate, and mixtures thereof In one embodiment, the aluminum compound is a calcium aluminate cement, commercially available under the trade name of Lumnite™ MG 4 or Cemfast™.

The aluminum additive is added to the concentrated stream in an amount sufficient for reactions with anionic soluble species to form an insoluble precipitate. A sufficient amount of the additive is added for a weight ratio ranging from 0.75:1 to 20:1 of additive to soluble species to be removed in one embodiment; a weight ratio of 2:1 to 5:1 in a second embodiment; and from 0.7:1 to 1.5:1 in a third embodiment. In one embodiment, the additive is added in an amount ranging from 500 ppm to 10,000 ppm. In another embodiment, the amount of additive ranges from 1,000 to 6,000 ppm. In a third embodiment, the additive is added in an amount ranging from 2,000 to 5,000 ppm.

In one embodiment, the pH of the effluent water is first adjusted to an alkaline value at which maximum removal of contaminants will occur. In one embodiment, the alkaline pH is between 9 and 13. In a second embodiment, the pre-selected pH is at least 11. The pH can be increased with lime supplementation. The alkaline pH can be maintained with the continuous addition of agents known in the art, e.g., lime CaO (quicklime) or Ca(OH)₂ (hydrated lime).

The treatment can be under agitated conditions for at least an hour. In another embodiment, the treatment ranges from 2-4 hours. In yet another embodiment, the treatment is for at least 3 hours. The treatment is at a temperature ranging from ambient to 60° C. in one embodiment, and from 40 to 80° C. in a second embodiment. The treatment generates a dense solid volume with a fairly fast settling rate, which solid can be subsequently removed using liquid-solid separation means known in the art to generate treated water. In one embodiment, the treated water contains less than 1 ppm fluoride, and less than 300 ppm sulfate. In one embodiment, the treated water contains less than 0.010 ppm nickel, less than 0.005 ppm manganese, less than 0.02 ppm aluminum, and less than 0.05 ppm zinc. In one embodiment, the treated water contains less than 0.003 ppm arsenic, less than 0.08 ppm molybdenum, less than 0.005 ppm vanadium, and less than 0.005 ppm antimony.

Carbonation—Neutral pH: After treatment, the treated and unfiltered water may be pumped to a mill tailings impoundment for storage. In one embodiment for recycling treated and filtered water for on-site or off-site re-use, the pH is adjusted towards the neutral range, e.g., less than 9, to meet local effluent discharge regulations and prevent deposition of hard carbonate scale in filters and distribution piping. In one embodiment, addition of carbon dioxide is performed in order to reduce the pH to meet discharge requirements into spillways. Carbon dioxide (CO₂) is a commonly used reagent for pH adjustment from the alkaline range. CO₂ reacts reversibly with water to form carbonic acid, which deprotonates (loses its hydrogen cation) causing the pH to decrease (due to H⁺in solution).

The neutralization results in precipitation of aluminum hydroxide and calcium carbonate. In one embodiment, the precipitate solids are settled in a clarifier and recovered for subsequent recycle. The recycled solids contain aluminum and calcium, which can be used as reactants in the lime/aluminum salt treatment step. The recycled solids also act as nucleation sites & aggregate growth for improved settling characteristics during clarification. In one embodiment, the recycled solids are returned to the lime/aluminum salt treatment step and to the carbonated slurry clarifier feed.

The treated water in the process combining nano-filtration treatment with enhanced chemical precipitation contains low discharge concentrations of COCs including metals, fluoride, SO₄⁻², total suspended solids (TSS), total dissolved solids (TDS), including low levels of Se, which is particularly difficult to remove. In one embodiment, the treated water has a TSS level of less than 10 mg/L, a TDS of less than 500 mg/L, including chloride and sulfate levels of less than 100 mg/L each, and less than 1 mg/L fluoride. With respect to heavy and base metal levels, the treated water in one embodiment contains less than 0.0001 mg/L of Cu, Cd, Co, Pb, and Sb each; less than 0.001 mg/L of Mo; and less than 0.005 mg/L of Se.

With the use of a nano-filtration step, the flow rate and size of the treatment system can be reduced at least 50% compared to a treatment system without a filtration step in one embodiment, and at least 65% in a second embodiment. Furthermore, the amount of sludge generated in the treatment system can be reduced by at least 10% in one embodiment compared to a system without a nano-filtration step, and at least 15% in a second embodiment. Lastly, with an intermediate nano-filtration step (prior to lime/aluminum salt treatment), the amount of aluminium salt required can be reduced by at least 10% compared to a treatment system without the nano-filtration step.

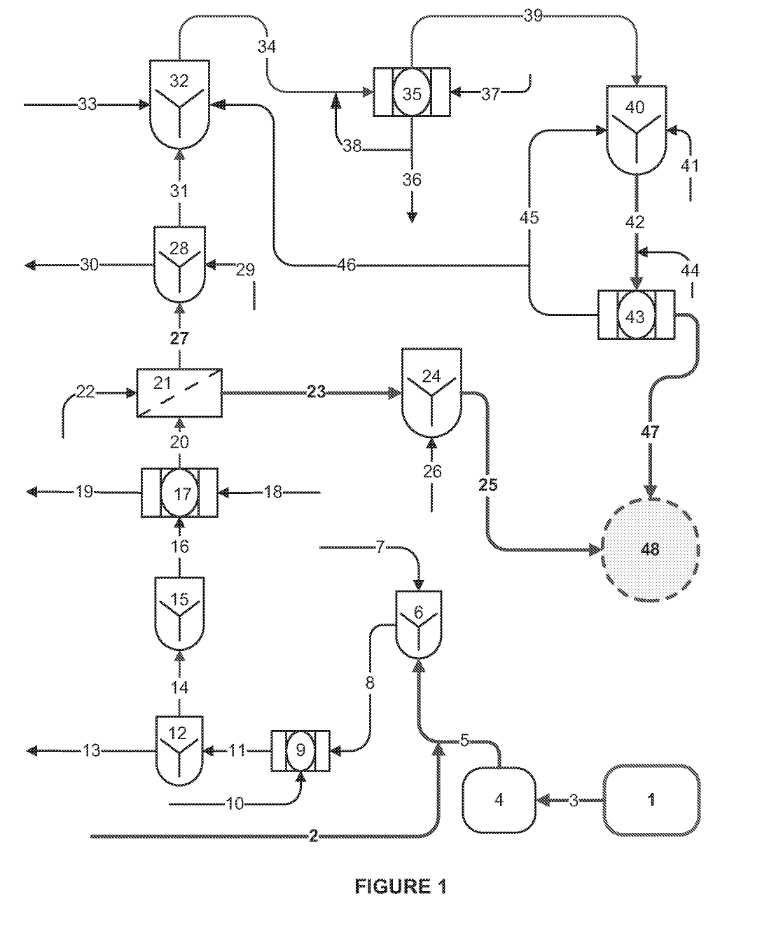

Reference will be made to FIG. 1 which is a block diagram schematically illustrating an embodiment of a process to treat acid mine drainage from an excavation. The process as shown comprises of a number of treatment zones, with one or more of the treatment zones operating in any of a batch flow mode, a sequential mode, semi-continuous or continuous flow mode having a continuous or periodic inflow.

In FIG. 1, permeate from filtering mill tailings slurry 1, having a pH of near neutral enters the treatment system through conduit 3, and is pumped co-currently through granular activated carbon (GAC) beds 4. The GAC removes soluble organics (e.g., pine oil, diesel, etc) in the mill tailings solution stream that accumulated in the waters from mill reagent addition during ore processing, which may cause fouling and plugging of the nano-filter membrane. The organic depleted feed 5 is combined with another AMD stream 2, yielding an effluent stream to aeration tank 6. In the aeration tank which is mechanically stirred and aerated, the water is treated with a metal ion source 7, e.g., iron chloride and hydrochloric acid or lime. Hydrochloric acid or lime (not shown) is added in sufficient amounts to control the effluent pH between 4 and 4.5.

The treated stream 8 containing suspended heavy and base metal precipitates, with pH of between 4 and 4.50, is pumped to a clarifier 9, wherein a high molecular weight pre-mixed anionic polymer 10 is added to flocculate and aggregate the dispersed iron oxy-hydroxide particulates. The flocculated slurry 11 is gravity fed to a sludge thickening tank 12 to create a dense sludge 13, which is filtered (not shown) and removed for disposal. The supernatant stream 14 is sent to a lime conditioning unit 15 for treatment at pH between 9.5 and 10.5. The slurry stream 16, containing suspended base metal hydroxides and gypsum, is pumped to a clarifier 17. In the clarifier, a pre-mixed anionic polymer 18 is added to flocculate and aggregate the particulates. The clarifier sludge 19 is pumped to a filter press (not shown) and removed for disposal. The supernatant 20 flows into a nano-filtration unit 21, that generates a permeate or treated stream 23 (about of 65 vol. % of stream 20) and a membrane reject stream 27 (about of 35 vol. % of stream 20) containing concentrated brine.

A phosphonate based anti-scalant 22 is added to the filtration unit to prevent precipitation of gypsum, calcium fluoride and magnesium hydroxide, and alleviate subsequent scaling and plugging of the membranes.

The permeate 23 flow undergoes carbonation 24 with pH adjustment to 7-8 with CO₂ gas stream 26. After carbonation, stream 25 is directed to a mixing tank 48, wherein it is blended with post-treated brine 47 and discharged to outfall or reused for industrial, irrigation, or other uses.

The membrane reject flow 27 is sent to a settling tank 28, wherein anionic polymer 29 is added to settle out super-saturated gypsum. The clarifier sludge 30 is pumped to a filter press (not shown) for filtering before disposal. Overflow 31 from the brine settling tank 28 enters a stirred tank 32, where Lumnite™ or Cemfast™ calcium aluminate cement 33 is added in conjunction with lime to a pH of 11-12, for removal of cationic and anionic soluble contaminants to target discharge standards.

After the aluminate treatment, the alkaline treated slurry 34 is pumped to a clarifier 35, where the addition of a non-ionic polymer 37 results in an underflow density of up to 6 wt % solids. A portion of the underflow slurry 38 may be recycled to the clarifier 35 to assist in seed nucleation and solids settling rates. The underflow solids 36 are filtered and removed for disposal. The clarified filtrate 39 is sent to carbonation tank 40 for treatment with CO₂ gas 41 to a pH of 7-8 to ensure effluent discharge pH requirements and trace soluble metals are met. A flocculent 44 is added to the discharge 42 to aggregate the dispersed particulates. The discharge 42 is directed to a clarifier 43, wherein clarifier underflow solids 45 may be partially recycled to the carbonation tank 40 to promote nucleation and growth of the particulates. In one embodiment as shown, a portion of the solids 46 is recycled to the stirred tank 32 to provide calcium and aluminum for the reaction.

The clarifier overflow 47 may be recycled back to the mill following combination with stream 25 in tank 48, and/or discharged to a spillway or outfall.

### EXAMPLES

The following illustrative examples are intended to be non-limiting.

The following acronyms are used in the examples and tables:

ICP: Iron Co-Precipitation, indicating the step to treat an effluent stream to remove metals including but not limited to molybdenum by ferric ion co-precipitation, with the addition to a rapidly mixed reactor using acidic FeCl₃ and pH adjustment to between 4-5 with lime slurry or hydrochloric acid, at a mass ratio of Fe:Mo ranging from 10:1 to 20:1.

LCA: Lime /Calcium Aluminate precipitation, indicating a step to treat an effluent stream by the addition of lime and calcium aluminate in a stirred reactor for a total residence time of 3 hours, with the addition of lime to a pH of about 11.5 to 12.7 to precipitate out ettringite and metal hydroxides, at a mass ratio of Ca—Al to [F⁻+SO₄⁻²] of 1.1 to 1.

CBN: Carbonation, referring to a step wherein the pH is adjusted using CO₂ gas for carbonation, wherein a small split stream of the water to be treated is sparged with CO₂ gas from a cylinder. The split stream rich in carbonic acid is added to the alkaline effluent for treatment to bring the final pH of the solution to a range of approximately 7 to 8.

ECP: Enhanced Chemical Precipitation refers to a combination treatment of ICP, LCA, and CBN.

NF: Nano-Filtration, referring to a step wherein a concentrated brine and a clean permeate is produced by the use of a nano-filter employing a Film Tech NF-90 polyamide thin-film composite membrane, or equal.

Target test levels for all treated constituents are depicted in Table 1.

TABLE 1

| Metals | Target Conc |
|---|---|
| pH (Standard Units) | 6.6-8.8 |
| Al—Aluminum | 1.88 |
| Be—Beryllium | 0.004 |
| Ca—Calcium | — |
| Cd—Cadmium | 0.0005 |
| Co—Cobalt | 0.05 |
| Cu—Copper | 0.011 |
| Fe—Iron | 1.0 |
| K—Potassium | — |
| Mg—Magnesium | — |
| Mn—Manganese | 1.78 |
| Mo—Molybdenum | 1.89 |
| Na—Sodium | — |
| Ni—Nickel | 0.063 |
| Pb—Lead | 0.0032 |
| Se—Selenium | 0.005 |
| Si—Silicon | 5.0 |
| Zn—Zinc | 0.149 |

General chemistry/Anions

| | |
|---|---|
| Chloride | 250 |
| Fluoride | 1.6 |
| Sulfate | 600 |
| Total Dissolved Solids (TDS) | 1,000 |
| Total Suspended Solids (TSS) | 20 |

All concentrations are in mg/L unless otherwise noted.

### Example 1

Streams from different sources, e.g., underground mine water/springs, collected mine ground water, flotation tail filtrate, etc. were combined for treatment into a batch composite stream “A” with concentration (in mg/L) as indicated in Table 2.

“A” was subjected to iron co-precipitation step (ICP) for a reduction of Mo level to a fraction of the pre-ICP treatment level. The treated water was analyzed for cations, anions, TDS and other constituents. The results are shown in Table 2.

A portion of “A” was subject to an Enhanced Chemical Precipitation (ECP) treatment, combining iron co-precipitation (ICP), lime/calcium aluminate precipitation (LCA), and carbonation (CBN). The treated water was analyzed for cations, anions, TDS and other constituents, as shown in Table 2. All concentrations are in mg/L unless otherwise noted.

TABLE 2

| Metals | “A” | After ICP | After ECP |
|---|---|---|---|
| pH (Standard Units) | NM | 4.1 | 7.0 |
| Al—Aluminum [TR] | 17 | 16 | 1.5 |
| Be—Beryllium | 0.0065 | 0.0095 | <0.00051 |
| Ca—Calcium | 294 | 320 | 180 |
| Cd—Cadmium | 0.017 | 0.017 | <0.00014 |
| Co—Cobalt | 0.1 | 0.10 | 0.00028 |
| Cu—Copper | 0.023 | 0.23 | 0.0014 |
| Fe—Iron | 0.16 | <0.083 | <0.083 |
| K—Potassium | 19 | 19 | 17 |
| Mg—Magnesium | 81 | 77 | 0.034 |
| Mn—Manganese | 14 | 17 | 0.034 |
| Mo—Molybdenum [TR] | 1.8 | 0.0073 | 0.034 |
| Na—Sodium | 36 | 36 | 34 |
| Ni—Nickel | 0.23 | 0.24 | <0.002 |
| Pb—Lead | 0.00049 | 0.00036 | <0.00017 |
| Se—Selenium [TR] | 0.005 | 0.0041 | <0.0036 |
| Si—Silicon | 7.7 | 7.6 | 0.47 |
| Zn—Zinc | 2.3 | 2.5 | .031 |

General chemistry/Anions

| | | | |
|---|---|---|---|
| Chloride | 11 | NM | 75 |
| Fluoride | 11 | NM | 0.030 |
| Sulfate | 1255 | NM | 370 |
| Total Dissolved Solids (TDS) | 1,630 | 2,000 | 840 |
| Total Suspended Solids (TSS) | 23 | <5.0 | 7.5 |

TR: Total Recoverable;
NM: Not Measured

### Example 2

A sample of composite stream “A” from Example 1 was pretreated by ICP, followed by lime precipitation at pH 10, followed by flocculation with a pre-mixed anionic polymer to aggregate the particulates with removal of the solids through a filter press.

Clarified effluent after ICP and lime treatment (“ICP & Lime”) was subject to nano-filtration (NF), generating two streams, a membrane reject (“NF concentrate”) stream and a permeate stream. The streams were analyzed for cations, anions, TDS and other constituents, as shown in Table 3.

TABLE 3

| Metals | “A” | ICP & Lime | NF Concentrate | NF Permeate |
|---|---|---|---|---|
| pH | NM | 10.0 | 8.11 | 10.0 |
| Al—Aluminum [TR] | 17 | 2.6 | 0.24 | 0.28 |
| Ca—Calcium | 294 | 430 | 650 | 3.6 |
| Cd—Cadmium | 0.017 | 0.00016 | 0.00025 | <0.00014 |
| Co—Cobalt | 0.1 | 0.0024 | 0.0056 | <0.00016 |
| Cu—Copper | 0.023 | 0.003 | 0.0028 | <0.00069 |
| Fe—Iron | 0.16 | <0.083 | <0.083 | <0.083 |
| K—Potassium | 19 | 20 | 110 | 11 |
| Mg—Magnesium | 81 | 91 | 340 | 0.76 |
| Mn—Manganese | 14 | 12 | 20 | 0.051 |
| Mo—Molybdenum [TR] | 1.8 | 0.019 | 0.019 | <0.0014 |
| Na—Sodium | 36 | 39 | 120 | 11 |
| Ni—Nickel | 0.23 | 0.011 | 0.019 | <0.0020 |
| Pb—Lead | 0.00049 | <0.00017 | 0.00034 | <0.00017 |
| Se—Selenium [TR] | 0.005 | <0.0036 | 0.0092 | <0.0036 |
| Si—Silicon | 7.7 | 2.2 | 9.1 | 0.58 |
| Zn—Zinc | 2.3 | 0.014 | 0.016 | 0.0046 |
| TSS | 23 | 4 | 600 | <10 |
| TDS | 1,630 | 2,100 | 5,100 | 72 |
| Chloride | 11 | 75 | 240 | 23 |
| Fluoride | 11 | 18 | 33 | 0.78 |
| Sulfate | 1,255 | 1,200 | 2,500 | 8.4 |

TR: Total Recoverable;
NM: Not Measured

### Example 3

The NF concentrate (brine) or reject stream of Example 2 was supersaturated with CaSO₄, with gypsum solids in the process of precipitating out of solution as the phosphonate based antiscalant lost its effect. The stream was further treated with the separation and removal of gypsum solids by anionic polymer addition and pre-settling. Following pre-settling, the concentrate was treated by LCA followed by CBN step, at a lime dose rate of approximately 2 g/L to reach a pH of 12.7 and a Ca—Al dose rate of 3.5g/L. The Ca—Al dosage was based on 1.1:1 mass ratio of Ca—Al: [SO₄²⁻+F]. A non-ionic polymer (Amerfloc 30 flocculent) was added at a concentration of 30 ppm to assist in solids settling post LCA step, for an observed settling rate of 1.5 to 1.7 gpm/ft². The polymer produced a thickened underflow stream containing up to 6 weight percent solids. The treated brine, following carbonation, met all test levels including selenium reduction by about 50% with the ECP process. The streams were analyzed for cations, anions, TDS and other constituents, as shown in Table 4. The aluminum level in post-treated concentrate was greater than the starting concentrate because of soluble Al ion release from the Ca—Al. However, when treated concentrate was re-blended with the clean NF permeate (Table 3), aluminum concentrations were well below target test levels (Table 1).

TABLE 4

| Metals | | “A” | NF Concentrate | Treated Concentrate |
|---|---|---|---|---|
| pH | S.U. | NM | 8.11 | 7.28 |
| Conductivity mS/cm | mS/cm | NM | 4,940 | 1,444 |

Metals

| | | | | |
|---|---|---|---|---|
| Al—Aluminum [TR] | mg/L | 17 | 0.24 | 2.2 |
| Ca—Calcium | mg/L | 294 | 650 | 120 |
| Cd—Cadmium | mg/L | 0.017 | 0.00025 | 0.00017 |
| Co—Cobalt | mg/L | 0.10 | 0.0056 | 0.00087 |
| Cu—Copper | mg/L | 0.023 | 0.0028 | 0.006 |
| Fe—Iron | mg/L | 0.16 | <0.83 | <0.083 |
| K—Potassium | mg/L | 19 | 110 | 110 |
| Mg—Magnesium | mg/L | 81 | 340 | 0.35 |
| Mn—Manganese | mg/L | 14 | 20 | 0.0038 |
| Mo—Molybdenum [TR] | mg/L | 1.8 | 0.019 | 0.0051 |
| Na—Sodium | mg/L | 36 | 120 | 120 |
| Ni—Nickel | mg/L | 0.23 | 0.019 | <0.0020 |
| Pb—Lead | mg/L | 0.00049 | 0.00034 | <0.00017 |
| Se—Selenium [TR] | mg/L | 0.005 | 0.0092 | 0.0044 |
| Si—Silicon | mg/L | 7.7 | 9.1 | <0.25 |
| Zn—Zinc | mg/L | 2.3 | 0.016 | 0.0058 |

General Chemistry and Anions

| | | | | |
|---|---|---|---|---|
| TSS | mg/L | 23 | 600 | <10 |
| TDS | mg/L | 1,630 | 5,100 | 900 |
| Chloride | mg/L | 11 | 240 | 210 |
| Fluoride | mg/L | 11 | 33 | 0.1 |
| Sulfate | mg/L | 1,255 | 2,500 | 240 |

TR: Total Recoverable;
NM: Not Measured

For purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. It is noted that, as used in this specification and the appended claims, the singular forms “a,” “an,” and “the,” include plural references unless expressly and unequivocally limited to one referent. The use of “including,” “comprising,” or “having,” “containing,” “involving,” and variations thereof herein, is meant to encompass the items listed thereafter and equivalents thereof as well as additional items.

This description uses examples to disclose the invention, including the best mode, and also to enable any person skilled in the art to make and use the invention. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A method for treating a discharge stream to reduce the concentration of metals and soluble contaminants, the discharge stream contains a concentration of soluble anionic species selected from sulfate, fluoride, and chloride, and one or more metal ions selected from aluminum (Al), antimony (Sb), molybdenum (Mo), vanadium (V), arsenic (As), copper (Cu), cadmium (Cd), cobalt (Co), lead (Pb), manganese (Mn), nickel (Ni), selenium (Se) and zinc (Zn), the method comprising:
contacting the discharge stream with a metal cation selected from divalent and trivalent metal cations and mixtures thereof, at a pre-select pH and in an amount effective for the metal cation to form at least an metal complex with one or more of the metals;
performing a liquid solid separation to remove the metal complex forming a first effluent stream;
adjusting the pH of the first effluent stream to a second pre-select pH to generate a first precipitate;
performing a liquid solid separation to remove the first precipitate to generate a second effluent stream;
passing the second effluent stream to a filtration device having at least a membrane element to generate a permeate stream and a reject stream supersaturated with calcium sulfate;
performing a settling and a liquid solid separation step to remove at least a portion of the calcium sulfate, forming a supernatant having a reduced concentration of calcium sulfate;
adding at least an aluminum salt to the supernatant for the soluble anionic species to react with the aluminum salt to form a second precipitate at an alkaline pH;
performing a liquid solid separation to remove the second precipitate to form a third effluent.

2. The method of claim 1, wherein the reaction of the soluble anionic species with the aluminum salt to form a precipitate is over a period of at least 3 hours.

3. The method of claim 1, further comprising:
carbonating the third effluent by adding a sufficient amount of CO₂ to adjust the pH to meet local discharge regulation.

4. The method of claim 1, wherein the reject stream has at least two times the concentration of soluble anionic species in the discharge stream.

5. The method of claim 1, wherein the third effluent has a TSS level of less than 10 mg/L, a TDS of less than 1000 mg/L, including chloride levels of less than 200 mg/L, sulfate levels of less than 300 mg/L and less than 1 mg/L fluoride.

6. The method of claim 1, wherein the first effluent contains less than 0.1 ppm of Mo, As, V, and Sb each.

7. The method of claim 1, wherein the permeate stream has a concentration of less than 0.0001 mg/L of Cu, Cd, Co, and Pb; less than 0.005 ppm of Ni and Zinc, less than 0.1 mg/L of Mo; and less than 0.005 mg/L of Se; and the

8. The method of claim 1, wherein lime is added to the supernatant for the soluble anionic species to form a precipitate at an alkaline pH.

9. The method of claim 1, wherein the discharge stream is an acid mine drainage.

10. The method of claim 1, wherein the contact with the one or more metal cations is at a pH between 3.5 and 5.0 and for a sufficient amount of time for at least 50% of the metals to form an complex with the metal cation.

11. The method of claim 1, wherein the effective amount of metal cation ranges from 6 to 50 ppm of metal cation to each ppm of metals contained in the acid mine drainage.

12. The method of claim 1, wherein the at least a metal cation is a trivalent metal ion or a divalent metal ion.

13. The method of claim 1, wherein the at least a metal cation is selected from ferrous sulfate, ferric chloride and ferric sulfate.

14. The method of claim 1, wherein the second pre-select pH ranges from 9 to 11.

15. The method of claim 1, wherein the metal cation is a divalent cation and wherein at least an oxidizing agent is added to the discharge stream to convert the divalent metal ion into a trivalent metal ion.

16. The method of claim 1, further comprising adding at least a flocculent to the first effluent stream to aggregate the first precipitate prior to performing a liquid solid separation to remove the first precipitate.

17. The method of claim 16, wherein the liquid solid separation is via clarification in an inclined plate settler.

18. The method of claim 1, wherein the liquid solid separation to remove the first precipitate is via coagulation.

19. The method of claim 1, wherein the at least an aluminum salt is selected from the group of aluminium chloride, aluminum chlorohydrate, polyaluminum chloride, aluminum sulfate, silicoaluminate, polyaluminum chlorosulfate, calcium chloroaluminate, calcium sulfoaluminate, sodium aluminate, potassium aluminate, calcium aluminate, and mixtures thereof.

20. The method of claim 19, wherein the at least an aluminum salt is calcium aluminate.

21. The method of claim 1, wherein the at least an aluminum salt is added in an amount ranging from 0.75:1 to 20:1 mass ratio of aluminum salt to soluble species to be removed.

22. A method for treating a discharge stream to reduce the concentration of heavy and base metals and soluble contaminants, the discharge stream containing a concentration of soluble anionic species selected from sulfate, fluoride, and chloride, and one or more metal ions selected from aluminum (Al), antimony (Sb), molybdenum (Mo), vanadium (V), arsenic (As), copper (Cu), cadmium (Cd), cobalt (Co), lead (Pb), manganese (Mn), nickel (Ni), selenium (Se) and zinc (Zn), and the method comprising:
contacting the discharge stream with an effective amount of ferric chloride at a pre-select pH to form at least a metal complex with at least one of the metals;
performing a liquid solid separation to remove the metal complex forming a first effluent;
adjusting the pH of the first effluent to 9 to 11 to generate a first precipitate;
performing a liquid solid separation to remove the first precipitate to generate a second effluent stream;
passing the first second effluent stream to a filtration device having at least a membrane element to generate a permeate stream and a reject stream supersaturated with calcium sulfate;
performing a settling and a liquid solid separation step to remove a portion of calcium sulfate from the reject stream, forming a supernatant having a reduced concentration of calcium sulfate;
adding a sufficient amount of calcium aluminate and lime to the supernatant for combining with at least one of the soluble anionic species to form a second precipitate at an alkaline pH;
performing a liquid solid separation to remove the second precipitate to form a third effluent.

23. The method of claim 22, wherein calcium aluminate is added in an amount ranging from 0.75:1 to 20:1 mass ratio of aluminum salt to soluble species to be removed.

23. The method of claim 22, wherein the permeate stream has a concentration of less than 0.0001 mg/L of Cu, Cd, Co and Pb; less than 0.005 ppm of Ni and Zinc, less than 0.1 mg/L of Mo; and less than 0.005 mg/L of Se;
the reject stream has from 2 to 10 times the concentration of soluble anionic species in the second effluent stream including a calcium sulfate concentration of at least 5,000 ppm;
the third effluent has a TSS level of less than 10 mg/L, a TDS of less than 1,000 mg/L, including chloride levels of less than 200 mg/L, sulfate levels of less than 300 mg/L and less than 1 mg/L fluoride

24. The method of claim 22, wherein the liquid solid separation to remove the first precipitate is via flocculation and clarification.
